(19) United States
(12) Patent Application Publication
(10) Pub. No.: US 2024/0044281 A1
(43) Pub. Date: Feb. 8, 2024

(54) CONTROL DEVICE OF INTERNAL COMBUSTION ENGINE

(71) Applicant: TOYOTA JIDOSHA KABUSHIKI KAISHA, Aichi-ken (JP)

(72) Inventor: Masahiro SATO, Susono-shi (JP)

(21) Appl. No.: 18/361,911

(22) Filed: Jul. 31, 2023

(30) Foreign Application Priority Data
Aug. 3, 2022 (JP) 2022-124364

(51) Int. Cl. F01P 11/16; F02D 45/00

(52) U.S. Cl. CPC F01P 11/16; F02D 45/00; F02D 2200/101; F01P 2025/62

(57) ABSTRACT

A control device for an internal combustion engine performs control of, when a water temperature of cooling water which cools the internal combustion engine is low, reducing load on the internal combustion engine and increasing a rotation speed of the internal combustion engine compared with a case in which the water temperature is high.

### CROSS-REFERENCE TO RELATED APPLICATION(S)

The present application claims priority to and incorporates by reference the entire contents of Japanese Patent Application No. 2022-124364 filed in Japan on Aug. 3, 2022.

### BACKGROUND

The present disclosure relates to a control device.

Patent Document 1 International Publication No. 2010/079609, a technique which restricts the load on an engine in order to reduce emission when the cooling water to cool the engine has a low water temperature and in a case of a catalyst-based engine warm-up retard is disclosed.

### SUMMARY

There is a need for providing a control device for an internal combustion engine which can reduce the PN emission in a case of a low temperature.

According to an embodiment, in a control device for an internal combustion engine, the control device, when a water temperature of cooling water which cools the internal combustion engine is low, performs control of reducing load on the internal combustion engine and increasing a rotation speed of the internal combustion engine compared with a case in which the water temperature is high.

### BRIEF DESCRIPTION OF THE DRAWINGS

FIG. 1 is a control system diagram of an engine according to an embodiment;

FIG. 2 is a diagram illustrating a region of PN emissions when engine cooling water is at a low water temperature;

FIG. 3 is a diagram illustrating a region of PN emissions when the engine cooling water is at a medium water temperature;

FIG. 4 is a diagram illustrating a region of PN emissions when the engine is fully warmed up;

FIG. 5 is a diagram illustrating an engine operating line in a first control example of the PN restriction control;

FIG. 6 is a diagram illustrating an engine operating line in a second control example of the PN restriction control;

FIG. 7 is a diagram illustrating a scheme of a control flow of the PN restriction control;

FIG. 8 is a diagram illustrating time charts of the first control example and the second control example of the PN restriction control and a case without the PN restriction control;

FIG. 9 is a diagram illustrating time charts of a case only with catalyst-based engine warm-up control and a case with the PN restriction control; and

FIG. 10 is a flow chart illustrating an example of the PN restriction control carried out by an electronic control device.

### DETAILED DESCRIPTION

In the related art, regarding operation conditions of an engine, if the temperature is low and deteriorates the volatility of fuel (a condition which cools parts such as an engine main body, lubricant oil, and cooling water) and the load on the engine is high, there is a problem that the number of particulate matters (PN: Particulate Number) contained in exhaust gas increases.

Hereinafter, an embodiment of a control device of an internal combustion engine according to the present disclosure will be described. Note that the present disclosure is not limited by the present embodiment.

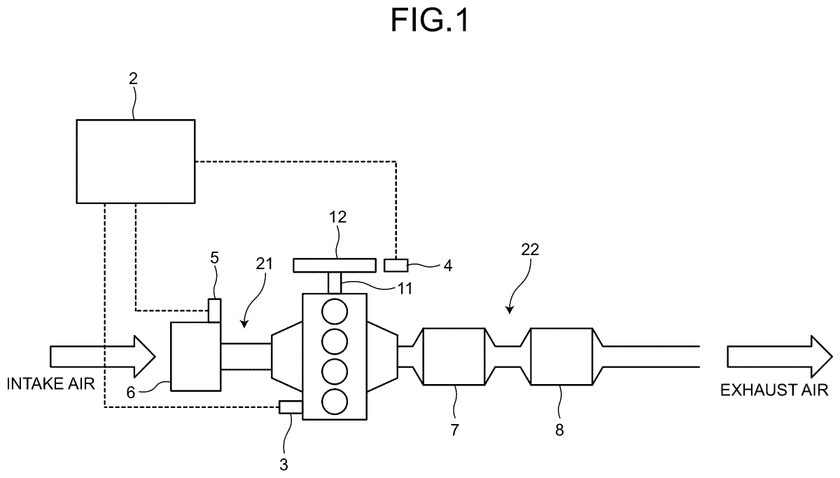

FIG. 1 is a control system diagram of an engine 1 according to the embodiment. As illustrated in FIG. 1, in the engine 1 which is an internal combustion engine mounted on a vehicle, an air intake passage 21 and an air exhaust passage 22 are provided to be communicated with each other. In the air intake passage 21, an air cleaner 6 which filtrates intake air, an airflow sensor 5 which is an air-volume detection means which detects the intake air volume, an unillustrated throttle valve which adjusts the intake air volume (engine load), etc. are disposed. In the air exhaust passage 22, a catalyst device 7, which is for purifying an exhaust gas emitted from the engine 1, and a muffler 8 are disposed.

Also, in the engine 1, a rotation sensor 4 which detects the rotation speed of the engine 1, a water-temperature sensor 3 which detects the water temperature of the engine cooling water which cools the engine 1, etc. are provided. The rotation sensor 4 detects, for example, the rotation speed of the engine 1 from the rotation angle or the rotation speed of a flywheel 12 provided at an end of a crankshaft 11 of the engine 1. The water-temperature sensor 3 detects, for example, the water temperature of the engine cooling water, which flows in an unillustrated cooling device provided in the engine 1.

An engine-rotation-speed signal from the rotation sensor 4 and a water-temperature signal from the water-temperature sensor 3 are input to an electronic control device 2, which controls the engine 1. Also, an intake-air-volume signal from the airflow sensor 5, a throttle-opening signal from an unillustrated throttle sensor which detects the opening of the throttle valve, etc. are input to the electronic control device 2. The electronic control device 2 can control the operation state (rotation speed and load) of the engine 1 based on these various signals.

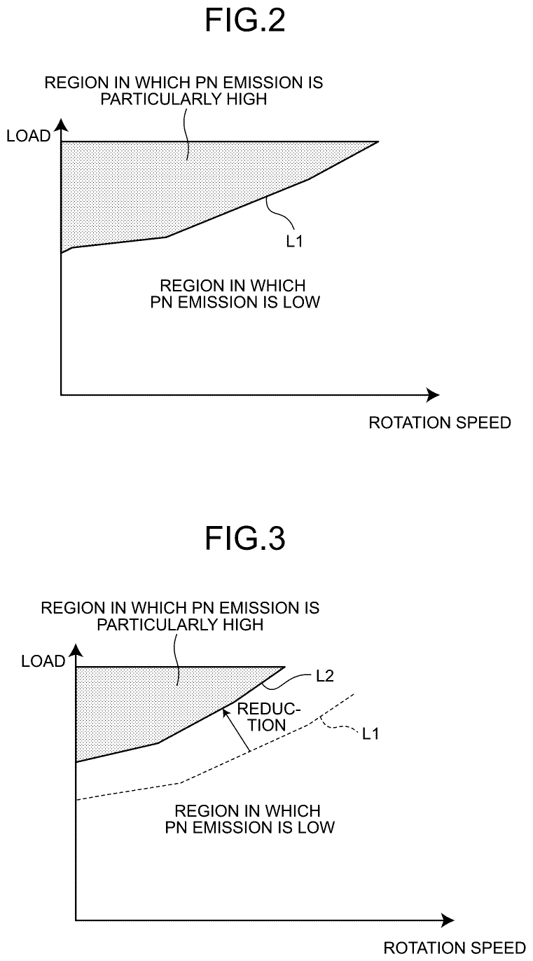

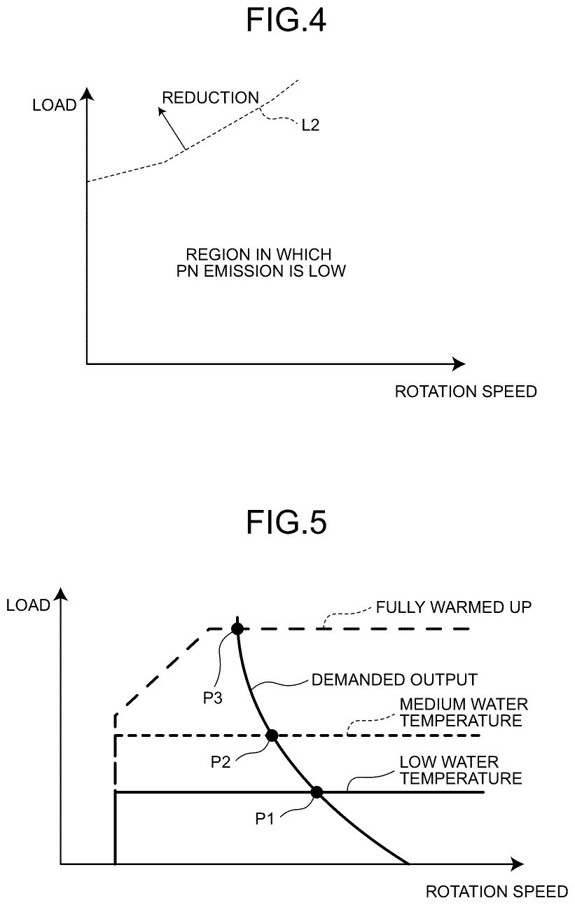

Next, outlines of PN emissions in the operation of the engine 1 will be described by referring to FIG. 2, FIG. 3, and FIG. 4. FIG. 2 is a diagram illustrating a region of PN emissions when the engine cooling water is at a low water temperature. FIG. 3 is a diagram illustrating a region of PN emissions when the engine cooling water is at a medium water temperature. FIG. 4 is a diagram illustrating a region of PN emissions when the engine 1 is fully warmed up. Note that a reference sign L1 in FIG. 2 and FIG. 3 represents a boundary line illustrating a boundary between a region in which the PN emissions are particularly high and a region in which the PN emissions are particularly low when the water temperature is low. Also, a reference sign L2 in FIG. 2 and FIG. 3 represents a boundary line illustrating a boundary between a region in which the PN emissions are particularly high and a region in which the PN emissions are particularly low when the water temperature is medium.

As illustrated in FIG. 2 and FIG. 3, there is a tendency that the lower the rotation speed and the higher the load in the operation state of the engine 1, the larger the PN emission. Conventionally, it is known that the PN emission increases when the load on the engine 1 is increased. On the other hand, the PN emission can be reduced by increasing the rotation speed of the engine 1. Also, as illustrated in FIG. 2, FIG. 3, and FIG. 4, the lower the water temperature of the engine cooling water, the larger the region in which the PN emission is particularly high in the low rotation speed side and the high load side in the operation state of the engine 1. As the warm-up of the engine 1 advances and the water temperature of the engine cooling water increases, the region in which the PN emission is high reduces.

Therefore, in order to reduce the PN emission emitted during the engine operation, the electronic control device 2 can execute PN restriction control which controls the engine 1 so as to limit the load on the engine 1 depending on the water temperature of the engine cooling water and achieve the operation state which avoids the region in which the PN emission is particularly high when the engine cooling water is at a low water temperature. In other words, as the PN restriction control, when the water temperature of the engine cooling water is low, the electronic control device 2 can execute the control of operating the engine 1 so that the load on the engine 1 is reduced and the rotation speed of the engine 1 is increased compared with a case in which the water temperature of the engine cooling water is high and that the predetermined low rotation speeds and the high-load region in which the PN emission from the engine 1 is equal to or higher than a predetermined amount.

FIG. 5 is a diagram illustrating an operating-point map of the engine 1 in a first control example of the PN restriction control. For example, as the first control example of the PN restriction control, as illustrated in FIG. 5, the electronic control device 2 uniformly reduces the load on the engine 1, depending on the water temperature of the engine cooling water, regardless of the rotation speed of the engine 1, to the level that avoids the region in which the PN emission is particularly high. Then, along with this, in order to ensure the demanded output of the engine 1, the rotation speed of the engine 1 is controlled so that an operating point P1 is achieved at the low water temperature, an operating point P2 is achieved at the medium water temperature, and an operating point P3 is achieved when the engine is fully warmed up. In the first control example of the PN restriction control, as the water temperature of the engine cooling water decreases, the load on the engine 1 is reduced, and the rotation speed of the engine 1 therefore becomes high to obtain the same demanded output.

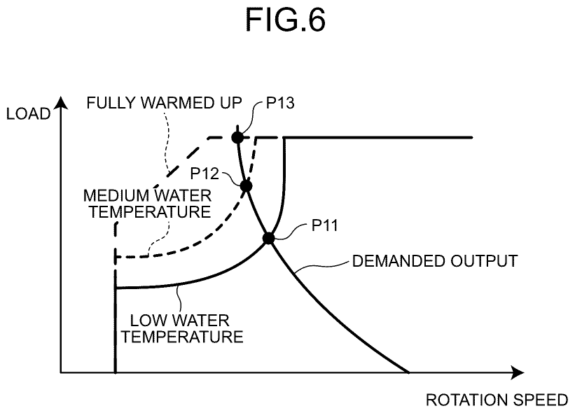

FIG. 6 is a diagram illustrating an engine operating line in a second control example of the PN restriction control. Note that the demanded output illustrated in FIG. 6 is the same as the demanded output illustrated in FIG. 5. As a characteristic of PN emissions, when the rotation speed of the engine 1 is increased, PN emissions can be reduced even when the engine 1 is under a condition of high load. Therefore, the electronic control device 2 may control the operation state of the engine 1 in the following manner. For example, as the second control example of the PN restriction control, as illustrated in FIG. 6, the electronic control device 2 carries out the control of limiting the rotation speed and the load of the engine 1 depending on the water temperature of the engine cooling water while avoiding low rotation speeds and high load so as to minimize the increase in the rotation speed of the engine 1 and reduce PN emissions. In FIG. 6, the electronic control device 2 controls the load and the rotation speed of the engine 1 so that an operating point P11 is achieved at the low water temperature, an operating point P12 is achieved at the medium water temperature, and an operating point P13 is achieved when the engine is fully warmed up. Note that the operating point P11 is the operating point with higher load and a lower rotation speed than those of the operating point P1 illustrated in FIG. 5, the operating point P12 is an operating point with higher load and a lower rotation speed than those of the operating point P2 illustrated in FIG. 5, and the operating point P13 is the operating point with the same load and rotation speed as those of the operating point P3 illustrated in FIG. 5.

In this manner, in the second control example of the PN restriction control, compared with the first control example, the load on the engine 1 can be increased with respect to the same demanded output of the engine 1 in the region in which the PN emission is low. Therefore, in the second control example of the PN restriction control, by restricting the increase in the rotation speed of the engine 1 to minimum, deterioration of the noise caused by increase in the rotation speed of the engine 1 can be restricted.

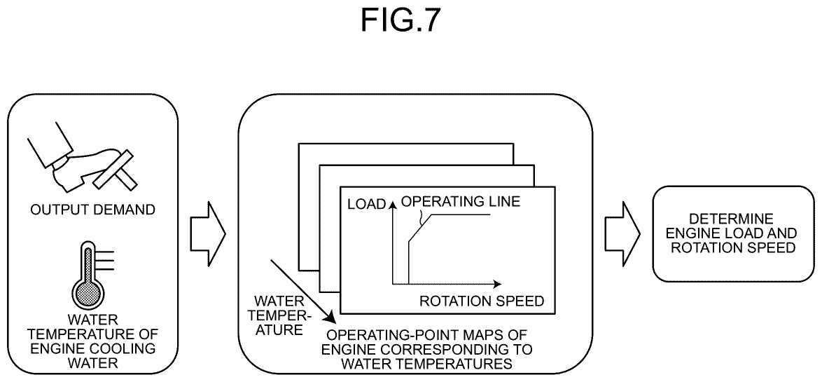

FIG. 7 is a diagram illustrating a scheme of a control flow of the PN restriction control. As illustrated in FIG. 7, based on the output demand from a user such as the degree of pressuring on a gas pedal and the water temperature of the engine cooling water (engine water temperature), the electronic control device 2 determines the load (torque) on the engine 1 and the rotation speed of the engine 1 by using the operating-point map of the engine 1 illustrating the relationships between the water temperature of the engine cooling water, the load on the engine 1, and the rotation speed of the engine 1 according to which the PN emission can be reduced. Regarding the operating-point map of the engine 1, for example, a plurality of operating-point maps, which have been obtained respectively for the water temperatures or water temperature ranges of the engine cooling water in advance by experiments or the like, are stored in a storage device or the like provided in the electronic control device 2. Also, in a Hybrid Electric Vehicle (HEV) provided with a motor which generates the drive force for driving the vehicle other than the engine 1, the demanded output per se for the engine 1 may be reduced by motor assist.

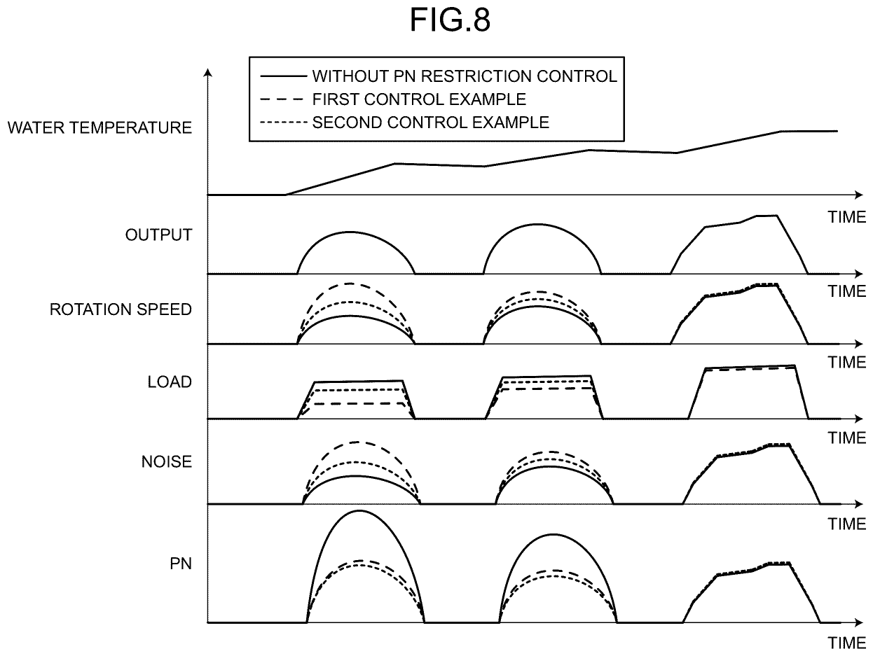

FIG. 8 is a diagram illustrating time charts of the first control example and the second control example of the PN restriction control and a case without the PN restriction control. Note that, in FIG. 8, the demanded output for the engine 1 is the same in the first control example and the second control example of the PN restriction control and in the case without the PN restriction control.

As illustrated in FIG. 8, without the PN restriction control, the rotation speed of the engine 1 is the lowest rotation speed, and the noise is suppressed the most; however, the engine 1 operates at the engine operating points in the region in which the PN emissions are particularly high in the low rotation speed side and the high rotation speed side, and the PN emissions are the highest. On the other hand, in the first control example and the second control example of the PN restriction control, since the engine 1 operates at the engine operating points avoiding the region in which the PN emissions are particularly high, as illustrated in FIG. 8, it can be understood that the PN emissions have been reduced in both control examples compared with the case without the PN restriction control. Also, the PN emissions are approximately equal in the first control example and the second control example of the PN restriction control. However, it can be understood that the second control example, which can increase the load on the engine 1 and reduce the rotation speed of the engine 1, has restricted noise more than the first control example.

Next, the points changed from emission reduction control will be described.

As control to limit the rotation speed and load on an engine when the engine is cold, there is catalyst-based engine warm-up. The points of changes and differences in use between the control according to the present embodiment and the catalyst-based engine warm-up control will be defined.

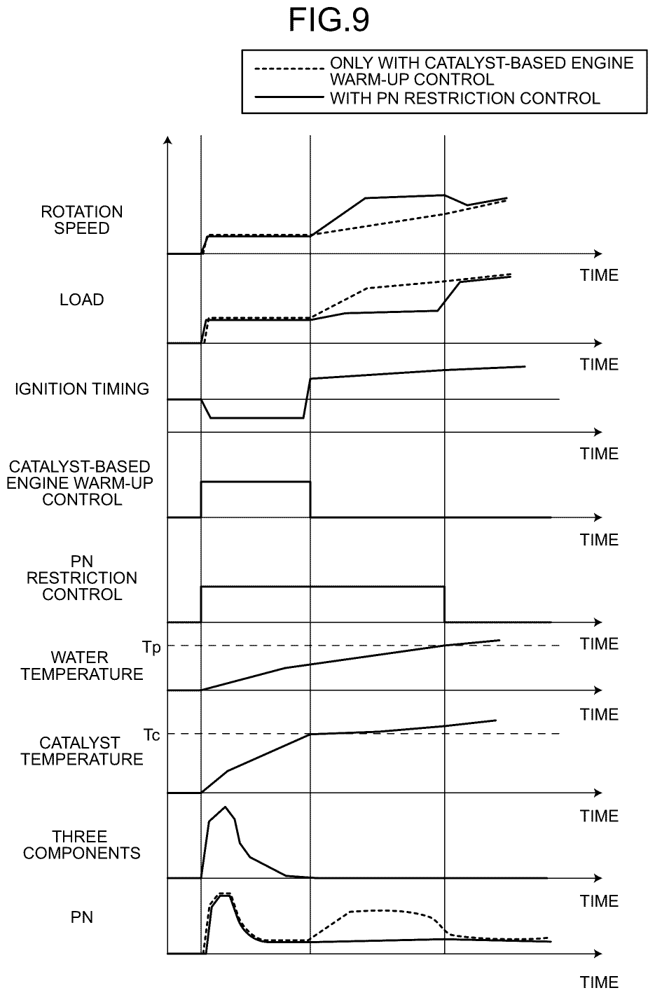

FIG. 9 is a diagram illustrating time charts of the control only with the catalyst-based engine warm-up control and the control with the PN restriction control.

In order to effectively carry out purification of HC, CO, and NOx (hereinafter, described as three components) contained in the exhaust gas by a catalyst, the electronic control device 2 can execute the catalyst-based engine warm-up control which is the control for warming up the catalyst, which is provided in the catalyst device 7, by the exhaust gas and enhancing activity. In the catalyst-based engine warm-up control, the temperature of the catalyst is actually measured or estimated, and control such as “load restriction” and “ignition timing retard” is continued until the temperature of the catalyst reaches an activating temperature Tc to operate the engine 1. Then, after the temperature of the catalyst reaches the activating temperature Tc and the catalyst is activated, operation of the engine 1 is carried out with the load corresponding to the output demand without restricting the load on the engine 1. On the other hand, since PN cannot be purified with the catalyst, the PN emission cannot be reduced by the catalyst-based engine warm-up control. Therefore, as illustrated in FIG. 9, in the case only with the catalyst-based engine warm-up restriction, if demanded load at the point when the catalyst-based engine warm-up ends is high, the engine 1 operates with the high load, and the PN emission increases.

The higher the temperature of the engine 1, in other words, the higher the water temperature of the engine cooling water, the lower the PN emission. Therefore, in the PN restriction control, the water temperature of the engine cooling water is monitored, and the control is continued until the water temperature becomes a water temperature Tp or higher at which the PN emission reduces and the output restriction of the engine 1 becomes unnecessary.

Note that, generally, the temperature of the catalyst reaches the activating temperature Tc faster than the temperature of the engine cooling water is increased to the temperature at which the PN emission is reduced. Also, the catalyst-based engine warm-up control significantly deteriorates fuel cost and is therefore not preferred to be continued for a long period of time. Therefore, when the catalyst-based engine warm-up control and the PN restriction control is requested at the same time like the case with the PN restriction control illustrated in FIG. 9, it is preferred to prioritize the catalyst-based engine warm-up control and execute the PN restriction control after the catalyst-based engine warm-up control is terminated. Note that, in the catalyst-based engine warm-up control, generally, the load on the engine 1 is low, and the load on the engine 1 at which the PN emission increases is basically not reached. Therefore, even if the catalyst-based engine warm-up control is carried out before the PN restriction control, the PN emission can be reduced.

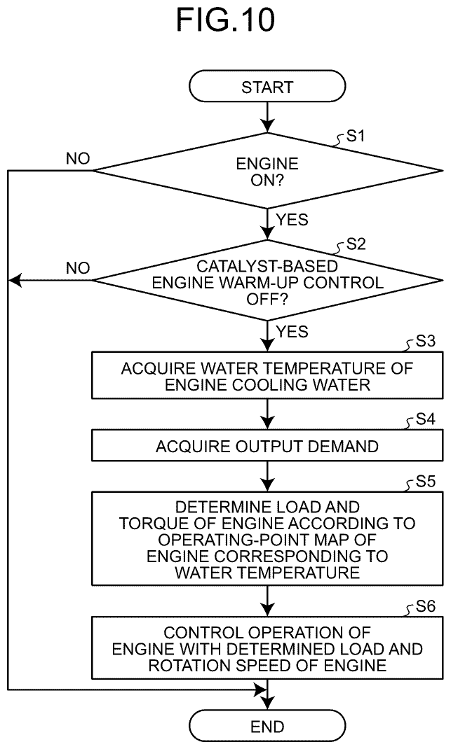

FIG. 10 is a flow chart illustrating an example of the PN restriction control carried out by the electronic control device 2. First, the electronic control device 2 judges whether the engine is ON or not (step S1). If the electronic control device 2 judges that the engine is not ON (No in step S1), the electronic control device 2 terminates the series of control. On the other hand, if the electronic control device 2 judges that the engine is ON (Yes in step S1), the electronic control device 2 judges whether the catalyst-based engine warm-up control is OFF or not (step S2). If the electronic control device 2 judges that the catalyst-based engine warm-up control is not OFF (No in step S2), the electronic control device 2 terminates the series of control. On the other hand, if the electronic control device 2 judges that the catalyst-based engine warm-up control is OFF (Yes in step S2), the electronic control device 2 acquires the water temperature of the engine cooling water (step S3). Next, the electronic control device 2 acquires the output demand for the engine 1 (step S4). Next, the electronic control device 2 determines the load and rotation speed of the engine 1 according to the operating-point map of the engine 1 illustrating the relationships between the water temperature of the engine cooling water, the load on the engine 1, and the rotation speed of the engine 1 according to which the PN emission can be reduced (step S5). Then, the electronic control device 2 controls operation of the engine 1 with the determined load and rotation speed (step S6). Then, the electronic control device 2 terminates the series of control.

By reducing the load on the engine 1 in the case of a low temperature, which deteriorates the volatility of fuel, by carrying out the PN restriction control, the electronic control device 2 can avoid the operation of the engine 1 in the high-load region in which the PN emission is high and can reduce the PN emission in the case of the low temperature.

The control device of an internal combustion engine according to the present disclosure exerts the effects that the operation in a high-load region, in which the PN emission is high, can be avoided by reducing the load in the case of a low temperature which deteriorates the volatility of fuel and that the PN emission can be reduced in the case of the low temperature.

According to an embodiment, an operation in a high-load region in which the PN emission is high can be avoided by reducing the load on the engine in the case of a low temperature which deteriorates the volatility of fuel, and the PN emission can be reduced in the case of the low temperature.

According to an embodiment, the noise caused along the increase in the rotation speed of an internal combustion engine can be restricted by minimizing the increase in the rotation speed of the internal combustion engine while avoiding predetermined low rotation speeds and a high-load region.

According to an embodiment, the load on the internal combustion engine and the rotation speed corresponding to the water temperature of the cooling water which cools the internal combustion engine can be determined.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A control device for an internal combustion engine, the control device being configured to, when a water temperature of cooling water which cools the internal combustion engine is low, perform control of reducing load on the internal combustion engine and increasing a rotation speed of the internal combustion engine compared with a case in which the water temperature is high.

2. The control device of the internal combustion engine according to claim 1, wherein the control operates the internal combustion engine while avoiding a region of a predetermined low rotation speed and high load in which a PN emission from the internal combustion engine is equal to or higher than a predetermined amount.

3. The control device of the internal combustion engine according to claim 1, wherein the control is carried out by determining the load on the internal combustion engine and the rotation speed of the internal combustion engine by using an operating-point map of the internal combustion engine illustrating a relationship between the water temperature, the load on the internal combustion engine, and the rotation speed of the internal combustion engine.
